(19) United States
(12) Patent Application Publication
(10) Pub. No.: US 2015/0254599 A1
(43) Pub. Date: Sep. 10, 2015

(54) TIME AND LOCATION MONITORING SYSTEMS AND RELATED METHODS

(71) Applicant: Remote Personal Web Solutions, Inc., Sacramento, CA (US)

(72) Inventor: Dainna McArthur, Citrus Heights, CA (US)

(21) Appl. No.: 14/640,619

(22) Filed: Mar. 6, 2015

Related U.S. Application Data
(60) Provisional application No. 61/949,386, filed on Mar. 7, 2014.

(51) Int. Cl. G06Q 10/06; G06F 17/30

(52) U.S. Cl. CPC G06Q 10/063114; G06F 17/3087

(57) ABSTRACT

A system for monitoring a worker's time and location by receiving a scheduled time and location of when and where a worker should begin a working appointment from a scheduler. The system receives a starting geolocation and a starting time associated with when the worker is at the starting geolocation from a client device associated with the worker. The system determines whether the starting geolocation is within a predetermined distance of the scheduled location and/or determines whether the starting time is within a predetermined timeframe of the scheduled time. If the worker is not within a predetermined distance of the scheduled location and/or within a predetermined timeframe of the scheduled time, the system may transmit a notification to a supervisor associated with the worker to indicate that the worker is not within a predetermined distance of the scheduled location and/or within a predetermined timeframe of the scheduled time.

### CROSS-REFERENCE TO RELATED APPLICATION

This application claims the benefit of U.S. Provisional Patent Application No. 61/949,386, filed Mar. 7, 2014, and entitled, “Time and Location Monitoring Systems and Related Methods,” which is hereby incorporated herein by reference in its entirety.

### BACKGROUND

Being able to monitor when a worker begins working and also being able to monitor where the worker is when they begin working is advantageous for the worker and those hiring the worker. This is especially true in service industries such as custodial services, sitting services, repair services, etc. Accordingly, there is a need for improved systems and methods for time and location monitoring. Various embodiments of the present system and methods recognize and address the foregoing considerations, and others, of prior art system and methods.

### SUMMARY OF THE VARIOUS EMBODIMENTS

A non-transitory computer-readable medium storing computer-executable instructions for, according to various embodiments, receiving, from a scheduler, an indication of a scheduled starting location. The scheduled starting location is a location associated with where a worker is scheduled to begin a working appointment. The system also receives, from a client device associated with the work, an indication of a starting geolocation, the starting geolocation comprising a location associated with a current location of the work. The system further determines whether the starting geolocation is within a first predetermined area at least partially based on: (1) the received scheduled starting location; and (2) the received starting geolocation. At least partially based on determining that the starting geolocation is not within the first predetermined area, the system transmits a starting location notification to a supervisor associated with the worker. According to various embodiments, the first predetermined area is an area comprising a predetermined distance from the scheduled starting location and the starting location notification indicates the starting geolocation is not within the first predetermined area.

A computer system, according to various embodiments, comprises at least one processor. The computer system is configured for receiving, from a scheduler, an indication of a scheduled starting time. The scheduled starting time comprises a time associated with when a worker is scheduled to begin a working appointment at a scheduled starting location. The system further receives, from a client device associated with the worker, an indication of a starting time. The starting time comprises a time associated with when the worker is at a starting geolocation. The system, according to various embodiments, also determines whether the starting time within a first predetermined timeframe of the scheduled starting time. At least partially based on determining that the starting time is not within the first predetermined timeframe of the scheduled starting time, the system transmits a starting time notification to a supervisor associated with the worker. The starting time notification indicates the starting time is not within the first predetermined timeframe of the scheduled starting time.

A computer system, according to various embodiments, comprising at least on processor. The computer system is configured for receiving, from a scheduler, an indication of: (1) a scheduled starting location, the scheduled starting location comprising a location associated with where a worker is scheduled to begin a working appointment; and (2) a scheduled starting time, the scheduled starting time comprising a time associated with when the worker is scheduled to begin the working appointment at the scheduled starting location. According to various embodiments, the system is further configured for receiving, from a client device associated with the worker, an indication of: (1) a starting geolocation, where the starting geolocation comprises a location associated with a current location of the worker; and (2) a starting time, where the starting time comprises a time associated with when the worker is at the starting geolocation. The system also, in various embodiments, determines whether the starting geolocation is within a predetermined distance of the scheduled starting location. According to various embodiments, the system determines whether the starting times is within a predetermined timeframe of the scheduled starting time. The system also transmits a notification to a supervisor associated with the worker at least partially based on: (1) determining that the starting geolocation is not within the predetermined distance of the scheduled starting location; and (2) determining that the starting time is not within the predetermined timeframe of the scheduled starting time. The notification indicates the starting geolocation is not within the predetermined distance of the scheduled starting location. The notification also indicates the starting time is not within the predetermined timeframe of the scheduled starting time.

### BRIEF DESCRIPTION OF THE DRAWINGS

Various embodiments of a system and method for monitoring whether a worker is on time and in the right location for an appointment is described below. In the course of this description, reference will be made to the accompanying drawings, which are not necessarily drawn to scale, and wherein:

FIG. 1 is a block diagram of an exemplary time and location monitoring system in accordance with an embodiment of the present system;

FIG. 2 is an exemplary schematic diagram of a computer, such as, for example, the monitoring server of FIG. 1, that is suitable for use in various embodiments;

FIG. 3A depicts a flowchart that generally illustrates various steps that may be executed by a Time and Location Monitoring Module that, for example, may be executed by the monitoring server of FIG. 1;

FIG. 3B depicts a flowchart that generally illustrates various steps that may be executed by the Time and Location Monitoring Module of FIG. 3A;

FIG. 3C depicts a flowchart that generally illustrates various steps that may be executed by the Time and Location Monitoring Module of FIG. 3B;

FIGS. 4-6 are screen displays according to a particular embodiment showing an exemplary user interface via which a scheduler can access the system;

FIG. 7 is a screen display according to a particular embodiment showing an exemplary user interface via which a worker can access the system; and

FIG. 8 is a screen display according to a particular embodiment showing an exemplary user interface via which a supervisor can access the system.

### DETAILED DESCRIPTION

Various embodiments now will be described more fully hereinafter with reference to the accompanying drawings. It should be understood that the invention may be embodied in many different forms and should not be construed as limited to the embodiments set forth herein. Like numbers refer to like elements throughout.

### Overview

A computer system, according to various embodiments, is configured to facilitate monitoring various start times, end times, and locations of a user (e.g., a worker). The computer system, in a particular embodiment, monitors a start time and location of a user (e.g., a worker) by, for example: (1) receiving a scheduled time that the worker is required to start a particular job and a scheduled location where the worker is required to be (or approximately supposed to be) at about the start time; (2) receiving, from a client device associated with the worker, an indication of: (i) a geolocation indicating the worker's location; and (ii) a start time for the worker (e.g., when the worker arrives at the geolocation); and (3) comparing the geolocation with the scheduled location and the start time with the scheduled time to determine whether the geolocation is within a predetermined distance of the scheduled location and whether the start time is within a predetermined timeframe of the scheduled time, respectively (e.g., to determine if the worker is on-time and at the correct location). If the system, in a particular embodiment, determines that the geolocation is not within the predetermined distance of the scheduled location and/or that the start time is not within the predetermined timeframe of the scheduled starting time, the system transmits a notification to a supervisor associated with the worker indicating that the worker is not on-time and/or in the wrong location.

Various additional implementations of a system and method for monitoring one or more workers are described below, after a brief discussion of an exemplary technical platform and a computer system architecture that may be used, for example, in implementing various aspects of this concept.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

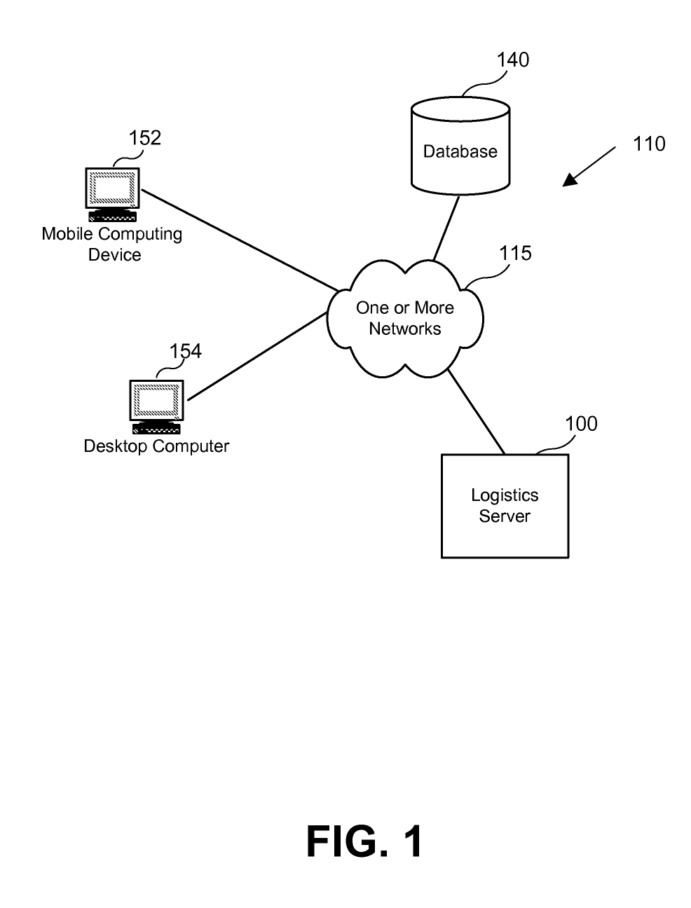

FIG. 1 is a block diagram of a System 110 according to a particular embodiment. As may be understood from this figure, the System 110 includes one or more Computer Networks 115, a Logistics Server 100, a Database 140, and one or more Client Devices such as a Mobile Computing Device 152 (e.g., such as a smart phone, a tablet computer, a wearable computing device, a laptop computer, etc.) and/or a Desktop Computer 154. In particular embodiments, the one or more Computer Networks 115 facilitate communication between the Logistics Server 100, Database 140, and one or more Client Devices 152, 154.

The one or more Computer Networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between the Logistics Server 100 and the Database 140 may be, for example, implemented via a Local Area Network (LAN) or via the Internet.

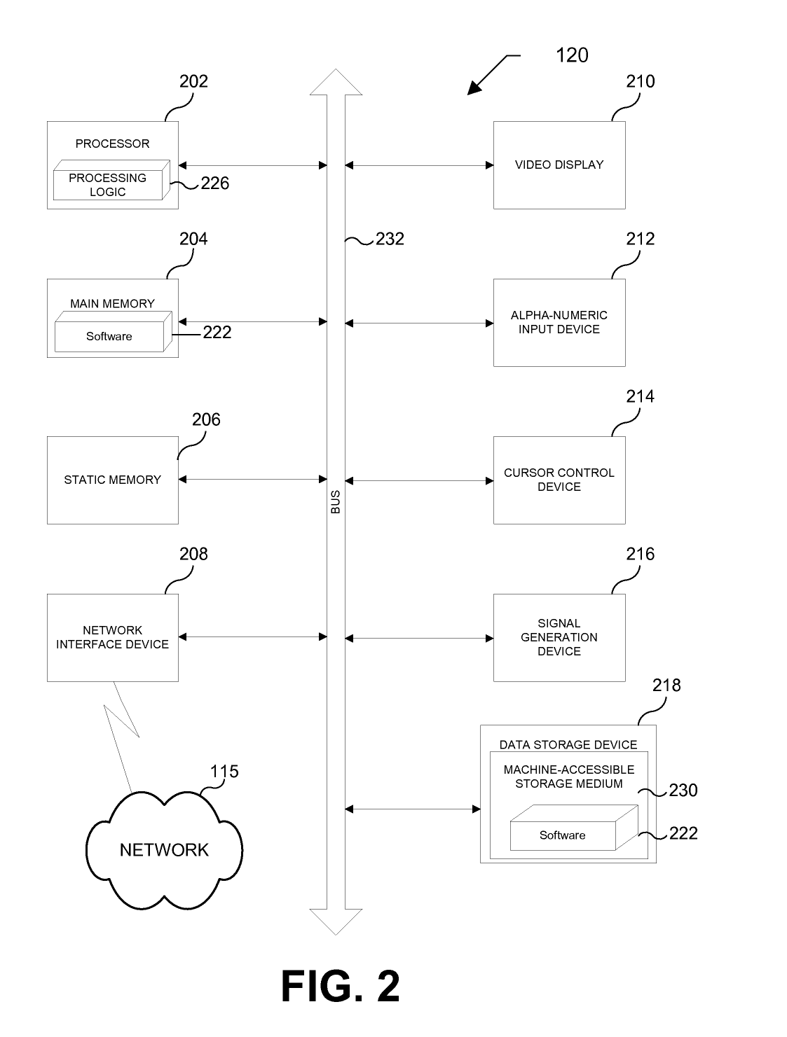

FIG. 2 illustrates a diagrammatic representation, in various embodiments, of the architecture of a Computer 120 that can be used within the System 110, for example, as a client computer (e.g., one of Client Devices 152, 154 shown in FIG. 1), or as a server computer (e.g., Logistics Server 100 shown in FIG. 1). In particular embodiments, the architecture of the Computer 120 may be suitable for use as a computer within the context of the System 110.

In particular embodiments, the Computer 120 may be connected (e.g., networked) to other computers in a LAN, an intranet, an extranet, and/or the Internet. As noted above, the Computer 120 may operate in the capacity of a server, a client computer in a client-server network environment, and/or as a peer computer in a peer-to-peer (or distributed) network environment. The Computer 120 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary Computer 120 includes a Processor 202, a Main Memory 204 (e.g., read-only memory (ROM), flash memory, dynamic random access memory (DRAM) such as synchronous DRAM (SDRAM) or Rambus DRAM (RDRAM), etc.), a Static Memory 206 (e.g., flash memory, static random access memory (SRAM), etc.), and a Data Storage Device 218, which communicate with each other via a Bus 232.

The Processor 202 represents one or more general-purpose processors such as a microprocessor, a central processing unit, or the like. More particularly, the Processor 202 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The Processor 202 may also be one or more special-purpose processors such as an application specific integrated circuit (ASIC), a field programmable gate array (FPGA), a digital signal processor (DSP), a network processor, or the like. The Processor 202 may be configured to execute Processing Logic 226 for performing various operations and steps discussed herein.

The Computer 120 may further include a Network Interface Device 208. The Computer 120 also may include a Video Display Unit 210 (e.g., a liquid crystal display (LCD) or a cathode ray tube (CRT)), an Alphanumeric Input Device 212 (e.g., a keyboard), a Cursor Control Device 214 (e.g., a mouse), and a Signal Generation Device 216 (e.g., a speaker).

The Data Storage Device 218 may include a Machine-Accessible Storage Medium 230 (also known as a non-transitory computer-readable storage medium or a non-transitory computer-readable medium) on which is stored one or more sets of instructions (e.g., Software 222) embodying any one or more of the methodologies or functions described herein. The Software 222 may also reside, completely or at least partially, within the Main Memory 204 and/or within the Processor 202 during execution thereof by the Computer 120—the Main Memory 204 and the Processor 202 also constituting computer-accessible storage media. The Software 222 may further be transmitted or received over a Network 115 via a Network Interface Device 208.

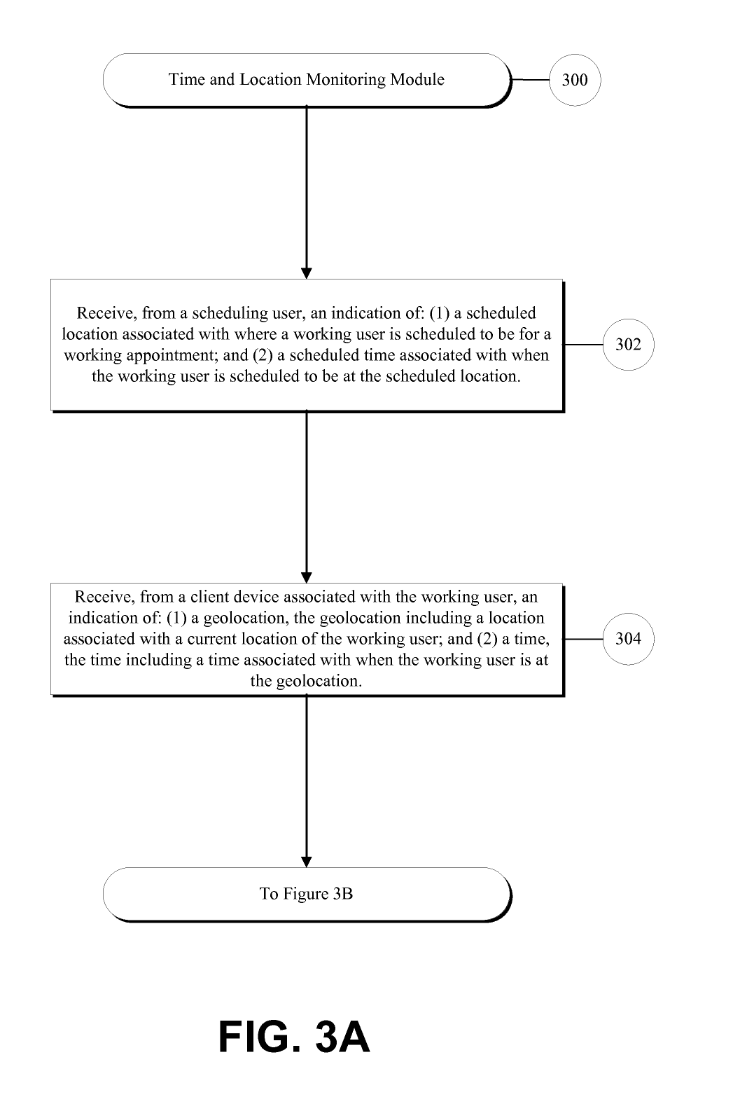

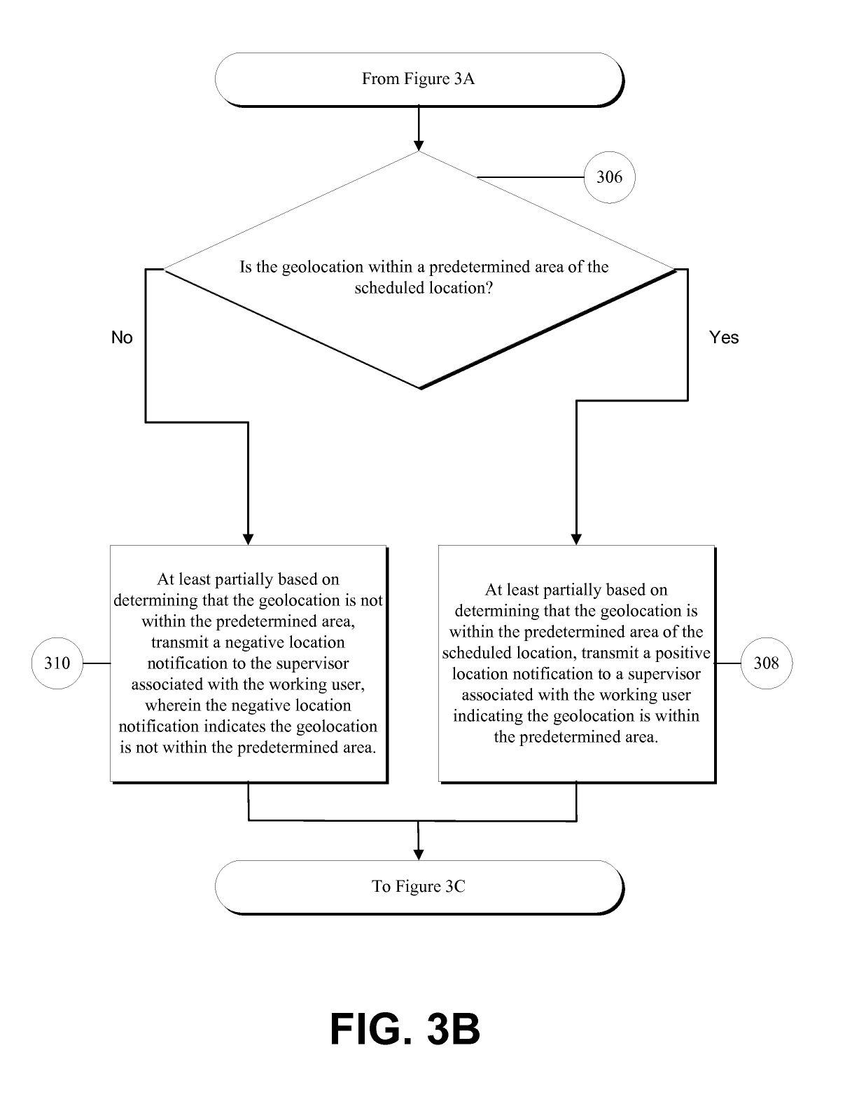

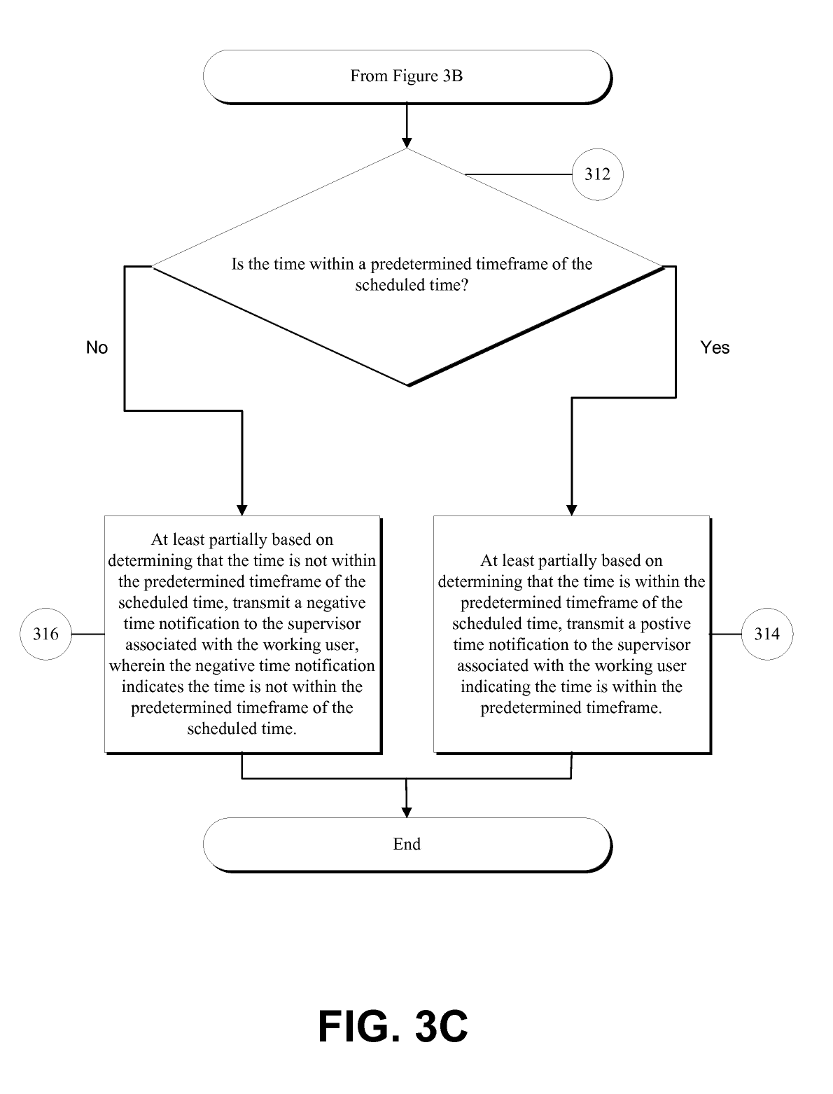

The Software 222 may represent any number of program modules, including, but not limited to, an operating system (not shown) and the Time and Location Monitoring Module 300 (as shown in FIGS. 3A, 3B, 3C). For simplicity and brevity, these modules are merely exemplary and may represent a number of program modules that control certain aspects of the operation of the Computer 120. The Time and Location Monitoring Module 300 is described in more detail below.

While the Machine-Accessible Storage Medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Time and Location Monitoring Module

As shown in FIGS. 3A, 3B, and 3C, certain embodiments of the Time and Location Monitoring Module 300 are configured to monitor a start time and location of a particular worker. The Time and Location Monitoring Module 300 may operate alone or in combination with one or more other modules to perform the functions shown in FIGS. 3A, 3B, and 3C. It should be understood by one skilled in the art that certain embodiments of the Time and Location Monitoring Module 300 may perform the functions shown in FIGS. 3A, 3B, 3C in an order other than the order shown in FIGS. 3A, 3B, and 3C. It should also be understood that various systems, when executing the Time and Location Monitoring Module 300, may omit particular functions or perform additional functions in performing the functions of the Time and Location Monitoring Module 300.

### Receiving Scheduled Locations and Times

When executing the Time and Location Monitoring Module 300, the system begins, at Step 302, by receiving, from a scheduler, an indication of: (1) a scheduled location associated with where a worker is scheduled to be for a working appointment; and (2) a scheduled time associated with when the worker is scheduled to be at the scheduled location.

The scheduler may be any suitable user capable of scheduling a worker (e.g., capable of making an appointment). In a particular embodiment, the scheduler is a parent of a child with disabilities and/or a guardian of a child with disabilities. In various embodiments, the scheduler is the supervisor of the worker. For example, the parent and/or guardian of the child may need temporary respite from caring for the child (e.g. to run errands such as going to the grocery store) and may wish to schedule a worker to care for the child. Continuing with this example, the parent or guardian either directly schedules the worker (e.g., via a user interface) or contacts the supervisor who schedules the worker.

In various embodiments, the worker is a social worker. In some embodiments, the worker is an employee of a childcare service. In particular embodiments, the worker is an independent contractor offering childcare services. In further embodiments, the worker is any other suitable type of service worker, including, but not limited to: 1) a cleaner (e.g., a person or people who clean homes or businesses; 2) a baby sitter; 3) a house sitter; 4) a repair person (e.g., someone who makes home or business repairs such as a plumber or air conditioning repair person; 5) a surveyor; and/or 6) a personal instructor (e.g., a piano teacher, a private swim lessons instructor, etc.).

The scheduled location may be any suitable location. According to particular embodiments, the scheduled location is a residence associated with the scheduler (e.g., the residence of the parent or guardian, or the residence of a relative of the parent or guardian, etc.). In some embodiments, the scheduled location is a workplace associated with the scheduler (e.g., the workplace of the parent or guardian, or the workplace of a relative of the parent or guardian, etc.). The scheduled location may be expressed in any suitable way. In various embodiments, the scheduled location is an address. In some embodiments, the scheduled location is a GPS location. In various embodiments, the scheduled location is expressed as longitudinal and latitudinal coordinates.

The system may receive the scheduled location in any suitable way. In a particular embodiment, the scheduler inputs the scheduled location into the system. In various embodiments, the supervisor inputs the scheduled location into the system (e.g., via one or more suitable client devices). In particular embodiments, the system receives the scheduled location from scheduling software, such as (but not limited to), an electronic calendar, an email program, etc.

The scheduled location may be any location associated with any particular point in time. In various embodiments, the scheduled location is a scheduled starting location associated with where the worker is scheduled to begin the working appointment (e.g., the scheduled starting location may be the residence of the parent of the child with disabilities where the worker is scheduled to begin the working appointment). In some embodiments, the scheduled location is a scheduled ending location associated with where the worker is scheduled to end the working appointment (e.g., the scheduled ending location may be the workplace of the parent of the child with disabilities where the worker is scheduled to end the working appointment).

In various embodiments, the scheduled starting location and the scheduled ending location are the same location. In other embodiments, the scheduled starting location and the scheduled ending location are different locations selected by the scheduler. For example, the scheduler may schedule the worker to start working (e.g., caring for a child) at a residence of the scheduler, and then schedule the worker to end working at the residence of the relative of the scheduler (e.g., transport the child to the residence of the relative of the scheduler).

The scheduled time may be any suitable time. In various embodiments, the scheduled time is a scheduled starting time for the worker to begin the working appointment. In some embodiments, the scheduled time is a scheduled ending time for the worker to end the working appointment. For instance, the scheduled time may be a time that the scheduler has scheduled the worker to start working and/or a time that the scheduler has scheduled the worker to stop working. The scheduled time may be any suitable time and/or time range. In a particular embodiment, the scheduled time includes a date, hour, minute, second, and post or ante meridiem (e.g., 7/30/2013 12:30:00 p.m.). In various embodiments, the scheduled time may be all day (e.g., 8:00 a.m. on 7/5/2013 until 8:00 a.m. on 7/6/13). In some embodiments, the scheduled time may be a range of time (e.g., 8:00 a.m. on 7/5/2013 until 8:00 p.m. on 7/5/13). In a particular example, the scheduled time may be a period of time totaling 2 hours (e.g., from 2:00 p.m. on 8/19/13 until 4:00 p.m. on 8/19/13).

The system may be configured to enable the scheduler to schedule the worker for a working appointment in any suitable way. In various embodiments, the system is configured to enable the scheduler to schedule the worker by enabling the scheduler to select the worker from a list (e.g., on a webpage and/or mobile application associated with the system). In one or more embodiments, the system is configured to enable the scheduler to schedule the worker in any other suitable way, including, but not limited to: (1) filing out a web form (e.g., filing out the desired suitable worker's information); and (2) submitting the suitable worker's information via email or other suitable electronic message to a client device and/or sever associated with the system. In further embodiments, the system may be configured to substantially automatically (e.g., automatically) select the worker if, for example, the scheduler does not select the worker (e.g., the system is configured to select a default worker).

The scheduler may schedule recurring days or times for a working appointment for a worker (e.g., recurring appointments) with the system. In various embodiments, the scheduler may schedule a working appointment for the worker one day every week (e.g., weekly on Fridays). In particular embodiments, the scheduler may schedule the worker for a working appointment one week every month (e.g., the first week of every month). In various embodiments, the scheduler may schedule the recurring working appointments to end after a particular date (e.g., Dec. 31, 2013).

The working appointment may be any suitable type of appointment. In particular embodiments, the working appointment is an appointment to care for a child with disabilities. In various embodiments, the working appointment is an appointment to care for more than one child. For example, the scheduler may schedule the worker for a working appointment to care for one child with disabilities and one child without disabilities.

### Receiving Time and Location

At Step 304, the system receives, from a client device associated with the worker, an indication of: (1) a geolocation, where the geolocation is a location associated with a current location of the worker; and (2) a time, where the time is associated with when the worker is at the geolocation. In a particular embodiment, the indication of the geolocation may be received substantially automatically (e.g., automatically) from the client device associated with the worker when the worker accesses the system. In various embodiments, the indication of the geolocation may be received manually from the client device associated with the worker. For instance, the worker may manually select to send the geolocation associated with the current location of the worker to the system.

The geolocation may be any suitable geolocation associated with the current geographical position of the worker. In various embodiments, the geolocation is an address, ZIP code, GPS coordinates, or region of the current position of the worker. In various embodiments, the geolocation is a predetermined range of distance around the current geographical position of the worker (e.g., the geolocation may be a quarter-mile circumference around the GPS coordinates of the current position of the worker). In particular embodiments, the geolocation is a longitudinal and latitudinal coordinate associated with the position of the worker. In some embodiments, the longitudinal and latitudinal coordinate geolocation may be compared to a database of known addresses to indicate a known address. For example, the database may contain the geolocation and address of a particular scheduler and the geolocation of the worker may be the same as the geolocation and address of the particular scheduler.

The geolocation may be any location associated with a point in time. In various embodiments, the geolocation is a starting geolocation associated with where the worker is scheduled to begin the working appointment. In a particular embodiment, the geolocation is a location where the worker first accessed the system. For example, the system may receive an indication of the worker start time substantially automatically (e.g., automatically) when the worker logs in to the system from the client device (e.g., clocks-in).

In various embodiments, the geolocation may be an ending geolocation associated with where the worker ended the working appointment. For example, the geolocation may be a location where the worker last accessed the system (e.g., clocks-out). For instance, the system may receive an indication of the worker clocking-out from a manual input from the worker on a client device.

The system may be configured to receive the indication of the time associated with when the worker is at the geolocation in any suitable way. In a particular embodiment, the indication of the time may be received substantially automatically (e.g., automatically) from the client device associated with the worker when the worker accesses the system. In one or more embodiments, the system may automatically receive the current time when the worker logs onto the system (e.g., the system receives the current time of 12:00 p.m. on 7/30/13).

In various embodiments, the indication of the time may be received manually from the client device associated with the worker. In a particular embodiment, the worker may manually select to transmit the time associated with when the worker is at the geolocation to the system (e.g., the worker enters the time 12:00 p.m. on 7/30/13 into the system). In a number of embodiments, the worker may access the system and input manually a time when the worker is at the geolocation via a user interface.

The time received from the worker may be any suitable time. In a particular embodiment, the time will include a date, hour, minute, second, and post or ante meridiem (e.g., 7/30/2013 12:30:00 p.m.). In various embodiments, the time may be a starting time (e.g., the time may be a time that the worker started working). In one or more embodiments, the first time a worker accesses the system may be when the user started working (e.g., the start time). In further embodiments, the time may be an ending time, such as the last time a worker accessed the system may be when the user stopped working. For example, the ending time may be a time the worker stopped working (e.g., clocked-out).

The system may be configured to receive intermittent indications of the geolocation of the worker. In various embodiments, the system is configured to receive an indication substantially automatically (e.g., automatically) of the geolocation of the worker every 30 minutes in between the worker start time and the worker end time. In some embodiments, the system is configured to receive an indication substantially automatically (e.g., automatically) of the geolocation of the worker every 15 minutes in between the worker start time and the worker end time.

Determining Whether the Geolocation is within a Predetermined Distance of the Scheduled Location

FIG. 3B depicts a flowchart that generally illustrates various continuing steps executed by the Time and Location Monitoring Module of FIG. 3A. At Step 306, the system determines whether the geolocation is within a predetermined area. According to various embodiments, the predetermined area is at least partially based on a predetermined distance from the scheduled location, which may be any suitable distance. In a particular embodiment, the predetermined distance may be expressed as miles, yards, or feet (e.g., about 1 mile, about 1,760 yards, or about 5,280 feet).

In various embodiments, the predetermined area is substantially a circle with the scheduled location as the center and the predetermined distance is the radius of the circle (e.g., the predetermined area is a circle encompassing a quarter-mile radius around the scheduled location). In further embodiments, the predetermined area may be a polygon, a square (e.g., the predetermined area encompasses one square-mile around the scheduled location) a rectangle, an irregular circular shape (e.g., an oval), and/or any other suitable shape based on the predetermined distance.

In particular embodiments, the system is configured to convert the geolocation and/or the scheduled location to be expressed in the same location terms to determine whether the geolocation is within the predetermined area. In some embodiments, for example, the system may be configured to convert the predetermined area into a set of longitudinal and latitudinal coordinates and compare it with the longitudinal and latitudinal coordinates of the geolocation (e.g., if the system receives the geolocation expressed as longitude and latitude coordinates) to determine whether the geolocation is inside of the predetermined area. In further embodiments, the system is configured to convert the geolocation to an address (e.g., if the system receives the geolocation expressed as GPS coordinates or if the geolocation is expressed some other way and the scheduled location is expressed as an address) and compares the geolocation (expressed as an address) with the predetermined area (e.g., the system converts the geolocation to an address and finds the address and the predetermined area on a map to determine if the geolocation is within the predetermined area).

At least partially based on determining that the geolocation is within the predetermined area, at Step 308, the system transmits a positive location notification to a supervisor associated with the worker. In various embodiments, the positive location notification includes the current geolocation of the worker. In particular embodiments, the positive location notification includes the scheduled location.

At least partially based on determining that the geolocation is not within the predetermined area, at Step 310, the system transmits a negative location notification to the supervisor associated with the worker, wherein the negative location notification indicates the geolocation is not within the predetermined distance of the scheduled location. In a particular embodiment, the negative location notification includes the geolocation, the scheduled location, and the predetermined distance from the scheduled location. In one or more embodiments, the negative location notification includes an indication of the determination of whether the geolocation is within the predetermined distance (e.g., the geolocation is within a quarter of a mile of the scheduled location). In particular embodiments, the negative location notification may contain the comparison between the geolocation and the scheduled location (e.g., the distance between the geolocation and the scheduled location).

The supervisor associated with the worker may be any suitable supervisor. In particular embodiments, the supervisor is the manager of the worker. In various embodiments, the supervisor may alternate depending upon the day of the week (e.g., A is the supervisor on Mondays, B is the supervisor on Tuesdays). In further embodiments, the supervisor is the scheduler. In one or more embodiments, the supervisor is the scheduler that scheduled to the user to be at the scheduled location.

The system may be configured to transmit the positive and/or negative location notification to the supervisor in any suitable way. In various embodiments, the system transmits the positive and/or negative location notification to the supervisor via email. In particular embodiments, the system transmits the positive and/or negative location notification to the supervisor via text message. In one or more embodiments, the system transmits the positive and/or negative location notification to the supervisor via automated call. In further embodiments, the system transmits the positive and/or negative location notification to the supervisor via a pop-up message (e.g., a pop-up notification on a webpage and/or mobile application).

Determining Whether the Time is within a Predetermined Timeframe

FIG. 3C depicts a flowchart that generally illustrates various continuing steps executed by the Time and Location Monitoring Module of FIGS. 3A and 3B. At Step 312, the system determines whether the time is within a predetermined timeframe of the scheduled time. In a particular embodiment, the predetermined timeframe includes a date, hour, minute, second, and post or ante meridiem (e.g., 7/30/2013 12:30:00 p.m.). In various embodiments, the predetermined timeframe may be 15 minutes before the scheduled time. In some embodiments, the predetermined timeframe may be 15 minutes after the scheduled time or any other suitable time range.

In various embodiments, the system is configured to determine whether the time is within the predetermined timeframe of the scheduled time by comparing the time with the scheduled time (e.g., by directly comparing the time with the scheduled time, such as comparing 12:01 p.m. with 12:00 p.m.). In particular embodiments, the system is configured to determine whether the time is within the predetermined timeframe of the scheduled time by comparing the time with the predetermined timeframe (e.g., comparing 12:01 p.m. with 11:45 a.m.-12:15 p.m.). In other embodiments, the system is configured to round the time to the nearest minute and compare it with the predetermined timeframe.

At least partially based on determining that the time is within the predetermined timeframe of the scheduled time, at Step 314, the system transmits a positive time notification indicating that the time is within the predetermined timeframe of the scheduled time. In various embodiments, the system is configured to include the current time associated with the worker in the positive time notification. In particular embodiments, the system is configured to include the scheduled time in the positive time notification.

At least partially based on determining that the time is not within the predetermined timeframe of the scheduled time, at Step 316, the system transmits a negative time notification to the supervisor associated with the worker, wherein the negative time notification indicates the time is not within the predetermined timeframe of the scheduled time. In a particular embodiment, the negative time notification includes the time, the scheduled time, and the predetermined timeframe from the scheduled time. In further embodiments, the negative time notification includes the determination of whether the time is within the predetermined timeframe. In still further embodiments, the negative time notification includes an indication of the comparison between the time and the scheduled time.

The system may be configured to transmit the positive and/or negative time notification to the supervisor in any suitable way (e.g., via email, text message, automated call, etc.). In some embodiments, the system may also be configured to transmit the positive and/or negative time notification to the scheduler.

### Screen Displays According to Particular Embodiments of the System

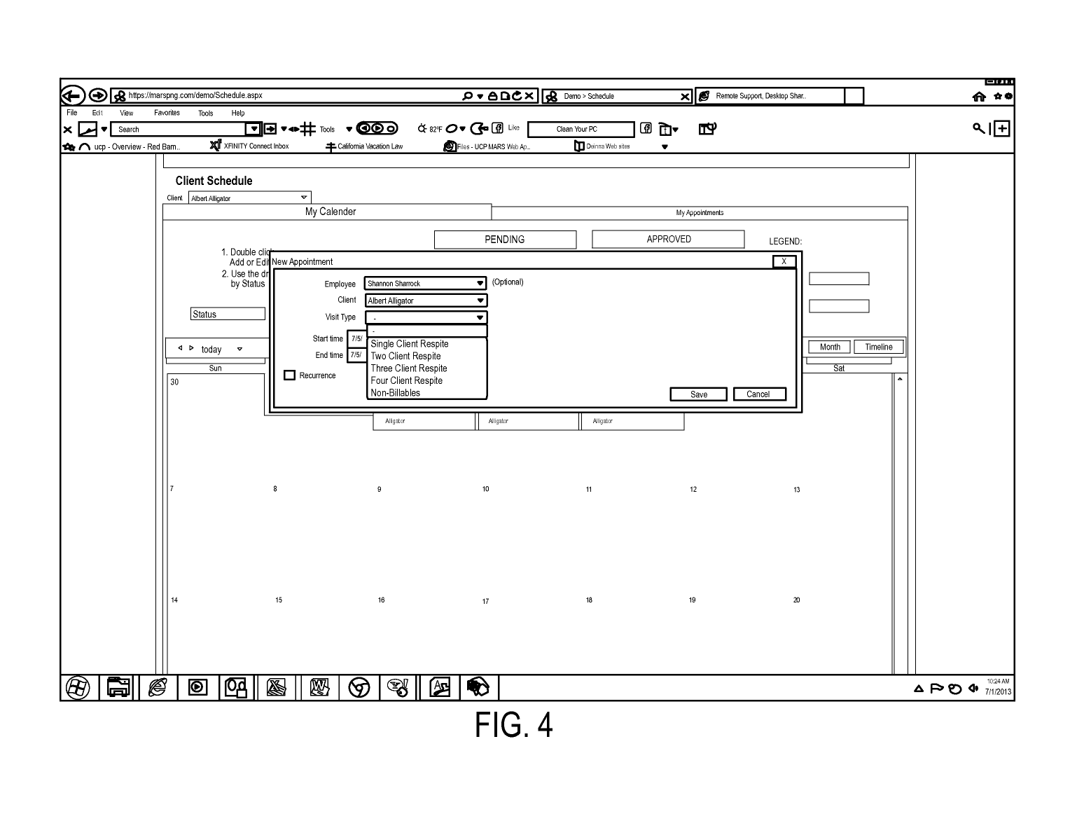

FIG. 4 is a screen display, according to a particular embodiment, showing an exemplary user interface via which a scheduler can access the system. As shown in FIG. 4, the options available to the scheduler are made available in a drop-down selection format. In particular embodiments, the scheduler is able to create a new appointment by optionally scheduling the worker (e.g., employee). The screen display also allows the scheduler to select which scheduler the appointment will be for (e.g., client). In various embodiments, the scheduler may select the type of work that the worker will perform. For example, the scheduler can schedule the worker to care for one, two, three, or four children (e.g., single, two, three, four client respite). In the embodiment shown, the scheduler may also schedule a starting time for the worker to start working. In addition, the scheduler may also schedule an ending time for the worker to stop working. In various embodiments, the user interface may appear over a calendar associated with the scheduler. In particular embodiments, once the scheduler has entered the information described above, the scheduler may either save or cancel the appointment.

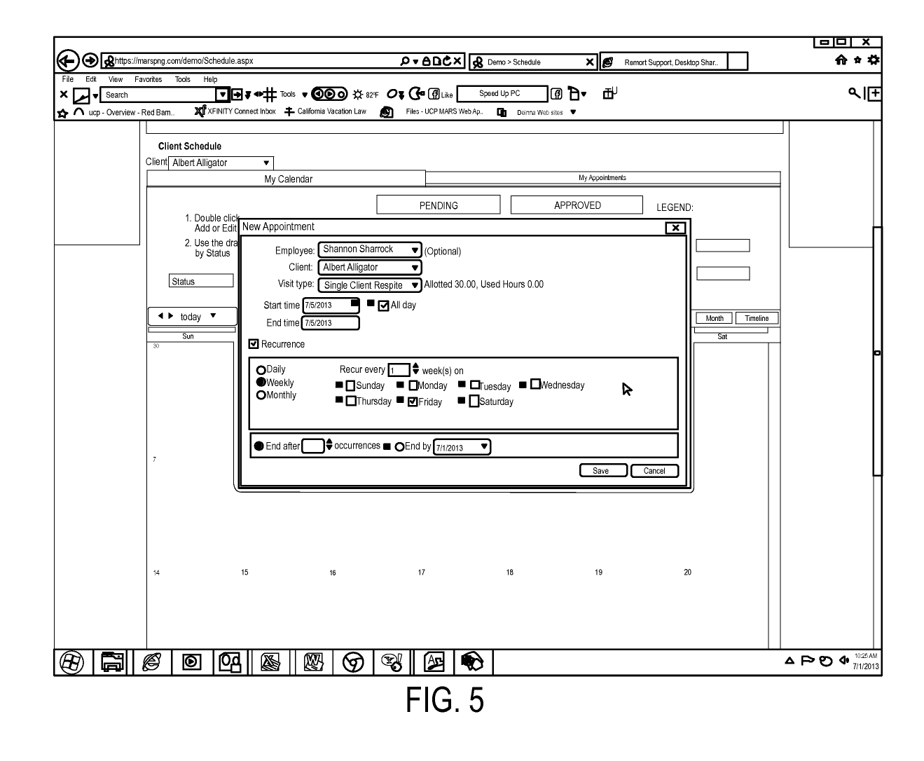

FIG. 5 is a screen display according to a particular embodiment showing an exemplary user interface via which a scheduler can access the system. The interface shown FIG. 5 enables the scheduler to select recurring appointments substantially as described above for FIG. 4. In scheduling the recurring appointment, the scheduler may selected whether the appointment reoccurrence is daily, weekly or monthly, which days the appointment reoccurs (e.g., Monday, Tuesday, Wednesday, etc.) and an ending to the reoccurring appointment (e.g., end after so many occurrences or by a date certain).

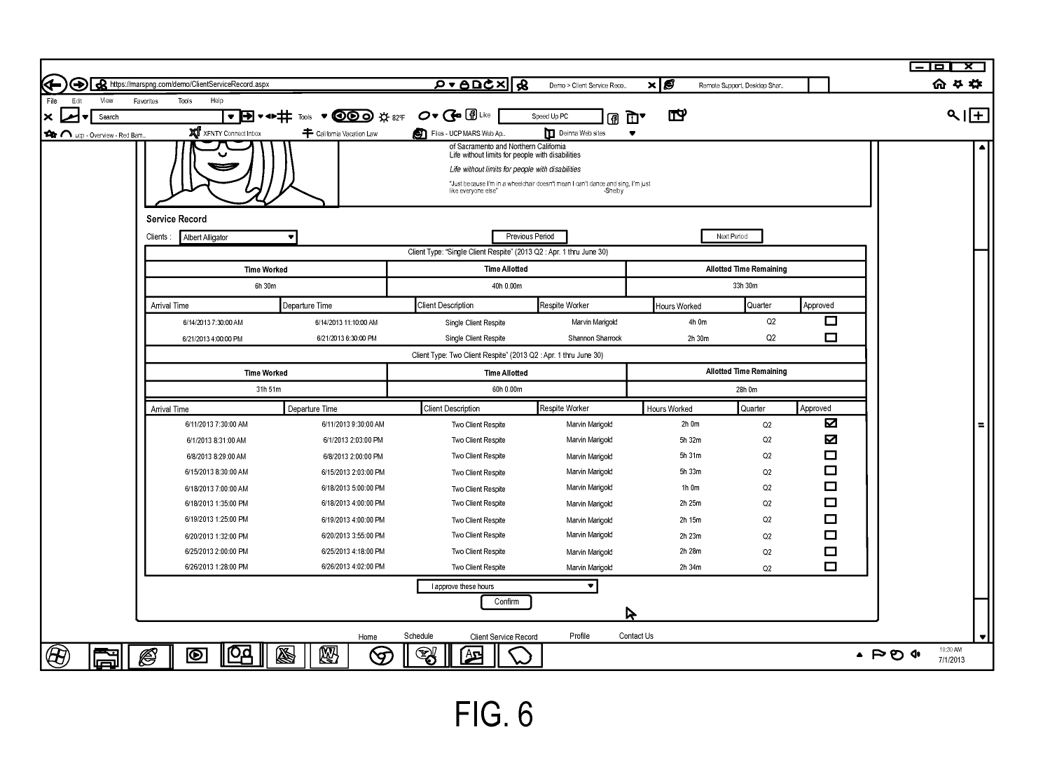

FIG. 6 is a screen display according to a particular embodiment showing an exemplary user interface via which a scheduler can access the system. As shown, the scheduler may view each of the completed appointments for a worker. For example, the scheduler is able to see the arrival time, departure time, type of work, name of the worker, and the hours worked by the worker. In particular embodiments, the scheduler is able to approve the hours worked by the worker.

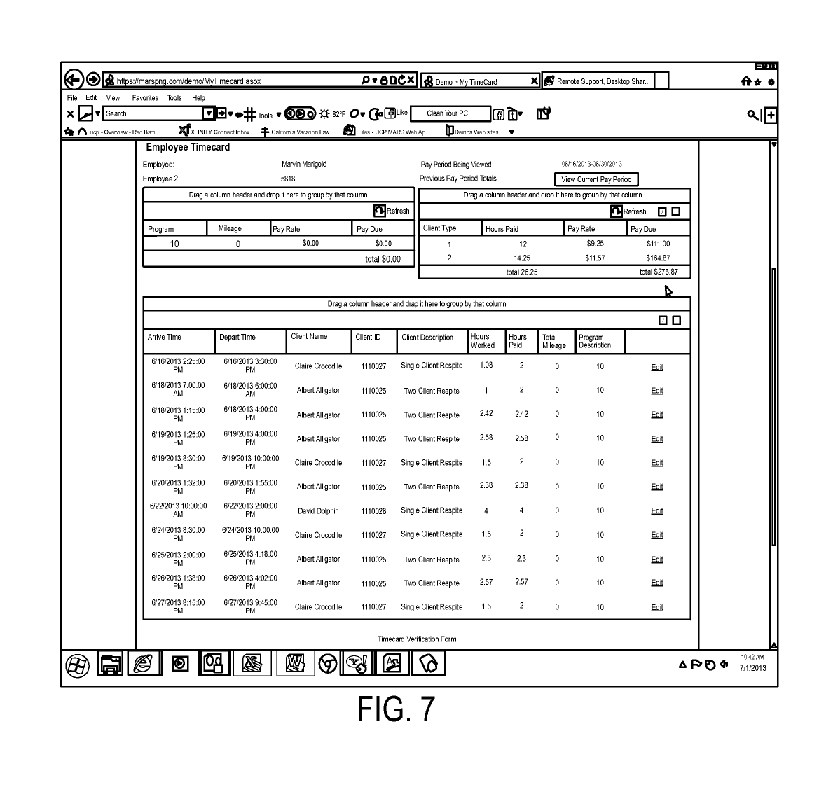

FIG. 7 is a screen display according to a particular embodiment showing an exemplary user interface via which a worker can access the system. In the embodiment shown, the user interface is a webpage built on a .net platform. The worker is able to view the following fields: arrival time, departure time, name of scheduler, type of work, hours worked by the worker, total mileage, and hours paid to the worker. In one or more embodiments, the worker is able to edit each of these fields by selecting a hyperlinked image of the word Edit.

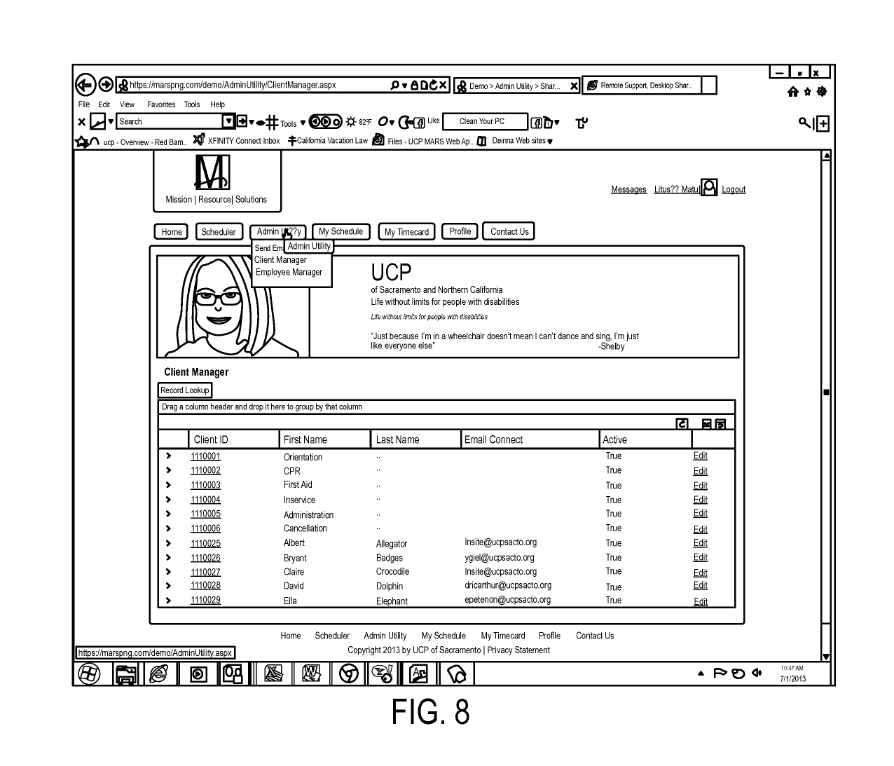

FIG. 8 is a screen display according to a particular embodiment showing an exemplary user interface via which a supervisor can access the system. According to particular embodiments, the supervisor may view a client manager page. There, the supervisor may view the contact information of the scheduler (e.g., name and e-mail). In various embodiments, the supervisor may edit the contact information of the scheduler.

### CONCLUSION

Many modifications and other embodiments of the present systems and methods will come to mind to one skilled in the art to which this present systems and methods pertains having the benefit of the teachings presented in the foregoing descriptions and the associated drawings. Therefore, it is to be understood that the present systems and methods is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A non-transitory computer-readable medium storing computer-executable instructions that when executed causes a computer to carry out the steps for:
(A) receiving, from a scheduler, an indication of a scheduled starting location, the scheduled starting location comprising a location associated with where a worker is scheduled to begin a working appointment;
(B) receiving, from a client device associated with the worker, an indication of a starting geolocation, the starting geolocation comprising a location associated with a current location of the worker;
(C) determining whether the starting geolocation is within a first predetermined area at least partially based on:
(i) the received scheduled starting location; and
(ii) the received starting geolocation;
(D) at least partially based on determining that the starting geolocation is not within the first predetermined area, transmitting a starting location notification to a supervisor associated with the worker,
wherein:
(i) the first predetermined area is an area comprising a predetermined distance from the scheduled starting location; and
(ii) the starting location notification indicates the starting geolocation is not within the first predetermined area.

2. The non-transitory computer-readable medium of claim 1, wherein the predetermined distance from the scheduled starting location is a distance between about zero miles and about one quarter of a mile.

3. The non-transitory computer-readable medium of claim 1, further storing computer-executable instructions for, at least partially based on determining that the starting geolocation is within the first predetermined area, transmitting a positive starting location notification to the supervisor indicating that the worker is within the first predetermined area.

4. The non-transitory computer-readable medium of claim 2, wherein the worker is selected from a group consisting of: (1) a social worker; and (2) a respite worker.

5. The non-transitory computer-readable medium of claim 4, wherein the worker is an independent contractor.

6. The non-transitory computer-readable medium of claim 3, wherein the scheduler is selected from a group consisting of: (1) a parent of a child with disabilities; and (2) a guardian of a child with disabilities; (3) a social worker supervisor.

7. The non-transitory computer-readable medium of claim 1, wherein the scheduler and the supervisor are a particular person.

8. The non-transitory computer-readable medium of claim 1, further storing computer-executable instructions for:
(A) receiving, from the scheduler, an indication of a scheduled ending location, the scheduled ending location comprising a location associated with where a worker is scheduled to end the working appointment;
(B) receiving, from the client device associated with the worker, an indication of an ending geolocation, the ending geolocation comprising a location associated with a current ending location of the worker;
(C) determining whether the ending geolocation is within a second predetermined area; and
(D) at least partially based on determining that the ending geolocation is not within the second predetermined area, transmitting an ending location notification to the supervisor associated with the worker,
wherein:
(i) the second predetermined area comprises a predetermined distance from the scheduled ending location; and
(ii) the ending location notification indicates that the ending geolocation is not within the second predetermined area.

9. The non-transitory computer-readable medium of claim 8, wherein the predetermined distance from the scheduled starting location and the predetermined distance from the scheduled ending location are a particular distance.

10. The non-transitory computer-readable medium of claim 1, further storing computer-executable instructions for:
(A) receiving, from a scheduler, an indication of a scheduled starting time, the scheduled starting time comprising a time associated with when the worker is scheduled to begin the working appointment at the scheduled starting location;
(B) receiving, from a client device associated with the worker, an indication of a starting time, the starting time comprising a time associated with when the worker is at the starting geolocation;
(C) determining whether the starting time is within a first predetermined timeframe of the scheduled starting time; and
(D) at least partially based on determining that the starting time is not within the first predetermined timeframe of the scheduled starting time, transmitting a starting time notification to the supervisor associated with the worker,
wherein:
(i) the first predetermined timeframe comprises a range of time before and after the starting time; and
(ii) the starting time notification indicates the starting time is not within the first predetermined timeframe of the scheduled starting time.

11. The non-transitory computer-readable medium of claim 10, further storing computer-executable instructions for, at least partially based on determining that the starting time is within the first predetermined timeframe of the scheduled starting time, transmitting a positive starting time notification to the supervisor, wherein the positive starting time notification comprises an indication that the starting time is within the first predetermined timeframe.

12. The non-transitory computer-readable medium of claim 10, further storing computer-executable instructions for:
(A) receiving, from a scheduler, an indication of a scheduled ending time, the scheduled ending time comprising a time associated with when the worker is scheduled to end the working appointment at the scheduled ending location;
(B) receiving, from a client device associated with the worker, an indication of an ending time, the ending time comprising a time associated with when the worker is at the ending geolocation;
(C) determining whether the ending time is within a second predetermined timeframe of the scheduled ending time; and
(D) at least partially based on determining that the ending time is not within the second predetermined timeframe of the scheduled ending time, transmitting an ending time notification to the supervisor associated with the worker,
wherein:
(i) the second predetermined timeframe comprises a range of time before and after the scheduled ending time; and
(ii) the ending time notification indicates the ending time is not within the second predetermined timeframe of the scheduled ending time.

13. The non-transitory computer-readable medium of claim 12, wherein the first predetermined timeframe comprises a range of about 7 minutes before the starting time and about 15 minutes after the starting time.

14. The non-transitory computer-readable medium of claim 12, wherein the first predetermined timeframe comprises a time range of about 15 minutes before the starting time and about 15 minutes after the starting time.

15. The non-transitory computer-readable medium of claim 13, wherein the first predetermined timeframe and the second predetermined timeframe are the same.

16. The non-transitory computer-readable medium of claim 1, wherein the working appointment is selected from a group consisting of: (1) a childcare appointment; (2) a respite care appointment; and (3) a social services appointment.

17. A computer system comprising:
at least one processor, wherein the computer system is configured for:
(A) receiving, from a scheduler, an indication of a scheduled starting time, the scheduled starting time comprising a time associated with when a worker is scheduled to begin a working appointment at a scheduled starting location;
(B) receiving, from a client device associated with the worker, an indication of a starting time, the starting time comprising a time associated with when the worker is at a starting geolocation;
(C) determining whether the starting time is within a first predetermined timeframe of the scheduled starting time; and
(D) at least partially based on determining that the starting time is not within the first predetermined timeframe of the scheduled starting time, transmitting a starting time notification to a supervisor associated with the worker,
wherein the starting time notification indicates the starting time is not within the first predetermined timeframe of the scheduled starting time.

18. The computer system of claim 17, wherein the computer system is further configured to receive the first predetermined timeframe from a client device associated with the scheduler.

19. The computer system of claim 17, wherein the computer system is further configured for:
(A) receiving, from the scheduler, an indication of the scheduled starting location, the scheduled starting location comprising a scheduled location associated with where a worker is scheduled to begin the working appointment;
(B) receiving, from a client device associated with the worker, an indication of a starting geolocation, the starting geolocation comprising a location associated with a current location of the worker;
(C) determining whether the starting geolocation is within a first predetermined area, wherein the first predetermine area comprises a predetermined distance from the scheduled starting location; and
(D) at least partially based on determining that the starting geolocation is not within the first predetermined area, transmitting a starting location notification to the supervisor associated with the worker,
wherein the starting location notification indicates the starting geolocation is not within the first predetermined area.

20. A computer system comprising:
at least one processor, wherein the computer system is configured for:
(A) receiving, from a scheduler, an indication of:
(i) a scheduled starting location, the scheduled starting location comprising a location associated with where a worker is scheduled to begin a working appointment;
(ii) a scheduled starting time, the scheduled starting time comprising a time associated with when the worker is scheduled to begin the working appointment at the scheduled starting location;
(B) receiving, from a client device associated with the worker, an indication of:
(i) a starting geolocation, the starting geolocation comprising a location associated with a current location of the worker;
(ii) a starting time, the starting time comprising a time associated with when the worker is at the starting geolocation;
(C) determining whether the starting geolocation is within a predetermined distance of the scheduled starting location;
(D) determining whether the starting time is within a predetermined timeframe of the scheduled starting time;
(E) transmitting a notification to a supervisor associated with the worker at least partially based on:
(i) determining that the starting geolocation is not within the predetermined distance of the scheduled starting location; and
(ii) determining that the starting time is not within the predetermined timeframe of the scheduled starting time,
wherein the notification indicates:
(i) the starting geolocation is not within the predetermined distance of the scheduled starting location; and
(ii) the starting time is not within the predetermined timeframe of the scheduled starting time.

21. The computer system of claim 20, wherein the computer system is further configured for:
(A) receiving information from a database of one or more known addresses;
(B) comparing the starting geolocation with the database of one or more known addresses;
(C) at least partially based on comparing the starting geolocation with the database of one or more known addresses, determining that the starting geolocation and the one or more known addresses are a particular address.
